(19) United States
(12) Patent Application Publication
(10) Pub. No.: US 2016/0332309 A1
(43) Pub. Date: Nov. 17, 2016

(54) ROBOTIC TOOL INTERCHANGE SYSTEM

(71) Applicant: Stratom, Inc., Boulder, CO (US)

(72) Inventors: JONATHAN HARRACH-SALAZAR, Erie, CO (US); MARK GORDON, Lafayette, CO (US); THOMAS GONZALEZ, Colorado Springs, CO (US)

(21) Appl. No.: 15/154,685

(22) Filed: May 13, 2016

Related U.S. Application Data
(60) Provisional application No. 62/161,101, filed on May 13, 2015.

(51) Int. Cl. B25J 15/04

(52) U.S. Cl. CPC B25J 15/0491

(57) ABSTRACT

A Gripper Remote Tool Change System (GRTCS) provides a locking guided tool changer assembly that interfaces with multiple tools, locks onto a tool holder, and is easily recognizable by a robot's gripper camera. The GRTCS provides an intermediate solution for remote tool changing that does not require a user to physically interact with the robot to change a tool. The GRTCS may be a completely mechanical product that does not require altering the electronics on the base robotic platform to which it may be attached.

### CROSS-REFERENCE TO RELATED APPLICATIONS

This application claims priority from U.S. Provisional Patent Application Ser. No. 62/161,101, filed on May 13, 2015, entitled “ROBOTIC TOOL INTERCHANGE SYSTEM,” assigned to the assignee hereof, and expressly incorporated by reference herein.

### FIELD

The present disclosure is directed to robotic tool systems and, more specifically, to a tool interchange system that may mount a tool to a robotic platform for remote use.

### BACKGROUND

Both military and civilian police and security personnel can encounter situations in which it is desirable to remotely inspect or handle dangerous or potentially dangerous items. For example, it may be desirable to inspect, handle, or work on objects in locations where it is not possible, or not desirable, to send a person. Remotely operated devices, such as remotely operated robots or unmanned ground vehicles (UGVs) may be used in such situations. Throughout this disclosure, reference is made to a system for use with an unmanned ground vehicle (UGV). The terms UGV and robot are used interchangeably herein, with the understanding that such a platform is one example in which a system of this disclosure may be used, and that the disclosed systems have broad applicability for use in other and different platforms.

UGVs commonly include an arm that has a gripper assembly, and a camera mounted on the arm or on the UGV platform itself. An operator located a safe distance away operates the UGV using a video feed from the camera to inspect or work on an object, using the arm and gripper assembly to move or otherwise access the item. In many cases the arm, as mentioned, has a gripper that may be used to grasp and rotate an object. In some situations, the gripper may hold another tool that may be useful in a particular situation, such as a probe for probing soil that may be used to cover a control line that could be used to detonate an explosive device. However, in many situations, it may be desirable to have another type of tool mounted to the arm. Such may be the case when a gripper assembly, or a tool held by the gripper assembly, would not be the most advantageous tool for a particular situation. For example, it may be desired to have a probe in some situations, and a cutting tool in other situations. Equipping a robotic arm with a different tool generally takes some time, which may not be desirable during high-stress and time-sensitive operations such as deactivation of explosive ordnance for example. Furthermore, in some cases an operator may not know the optimum tool for a particular job until an UGV is actually adjacent to the object of interest. Additionally, a UGV may be subjected to relatively harsh conditions, including exposure to wind, rain, dirt, sand, and high or low temperatures, to name a few. Thus, it also would be desirable for any tool system to be robust against exposure to various different elements. Accordingly, providing options to an operator of such a remotely operated device would be beneficial.

### SUMMARY

The present disclosure recognizes it would be useful to have a system in which a remotely operated device may have a library of available tools that may be selected by an operator. It would be advantageous to have such a system that is easily adaptable to allow the relatively fast exchange of different tools and that is straightforward to use. The present disclosure provides a Gripper Remote Tool Change System (GRTCS) which provides a locking guided tool changer assembly that interfaces with multiple tools, locks onto a tool holder, and is easily recognizable by a robot's gripper camera. According to various aspects, the present disclosure provides an intermediate solution for remote tool changing. A user does not need to physically interact with the robot and can accomplish the tool changing remotely. The GRTCS is a completely mechanical product and does not require altering the electronics on the base robotic platform to which it may be attached.

In some examples, a locking tool system is provided that interfaces with robotic grippers to allow robotic platforms to securely carry tools and swap between tools remotely. The locking tool system may include a modular tool holding system designed to integrate with robotic grippers. The system, in some examples, includes a collet, collet key, gripper guide, spring, and plunger key. The locking tool system may integrate with tool holders that are mounted to the robotic platform. The system can be used with a variety of tool types through the use of a spring pin, screw, or other securement mechanism.

In some aspects, a plunger key is integrated with tool holders on the robot's platform. The tool can be placed on the tool holder by engaging the plunger key. Engagement of the plunger key allows the tool to slide onto the tool holder and, to lock into place, the plunger key must disengage. To remove a tool, the operator may manipulate the gripper to close onto the gripper guide. Closing the gripper on the gripper guide engages the collet key to allow removal of the tool from the tool holder. Thus, various aspects of the disclosure provide a novel locking guided tool changer assembly that securely and robustly engages with a tool holder.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

FIG. 1 is a perspective and exploded view of a tool holder assembly according to various aspects of the present disclosure;

FIG. 2 is a perspective and exploded view of a locking guided tool changer assembly according to various aspects of the present disclosure;

FIG. 3 is section view of the locking guided tool changer mounted on tool holder according to various aspects of the present disclosure;

FIGS. 4A and 4B are perspective views of a locking guided tool changer according to various aspects of the present disclosure in engaged and disengaged configurations, respectively, according to various aspects of the present disclosure;

FIGS. 5A and 5B are perspective views of a locking guided tool changer according to various aspects of the present disclosure in engaged and disengaged configurations, respectively, rotated 90 degrees relative to the illustrations of FIG. 4, according to various aspects of the present disclosure.

FIGS. 6A and 6B illustrate isometric views of another example of a locking guided tool changer assembly;

FIGS. 7A and 7B illustrate side cross section views of the locking guided tool changer assembly of FIG. 6;

FIGS. 8A and 8B illustrate views of the locking guided tool changer assembly of FIG. 6;

FIGS. 9A and 9B illustrate top cross section views of the locking guided tool changer assembly of FIG. 6; and

FIG. 10 shows an exploded view of the locking guided tool changer assembly of FIG. 6.

### DETAILED DESCRIPTION

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, aspects and elements described with respect to certain embodiments may be combined in various other embodiments. It should also be appreciated that the following systems, devices, and components may individually or collectively be components of a larger system, wherein other procedures may take precedence over or otherwise modify their application.

The present disclosure is generally directed to systems and methods for mounting and using various different accessories on a robotic system such as a UGV. The present disclosure recognizes that UGVs commonly have features and characteristics that make easy and reliable tool change a challenge. For example, UGVs generally have low precision arms and controls which can result in unreliable arm placement at various preset positions. Furthermore, such arms commonly have significant amounts of flexibility and compliance. Additionally, the vehicle itself may not be level or particularly stable, further contributing to the low precision of movement of the arm. Thus, the present disclosure provides for reliable tool changing through simple engagement of the tool with the gripper assembly.

Additionally, it is beneficial for such vehicles to have failsafe conditions, such that tools are not dropped from the arm in the event of a power interruption. UGVs often also require operation in harsh environments with significant amounts of dirt, rocks, wind, moisture, and temperature extremes, to name a few. The present disclosure provides systems and methods for connection and operation of different tools to a UGV that provide efficient and reliable operations under such conditions.

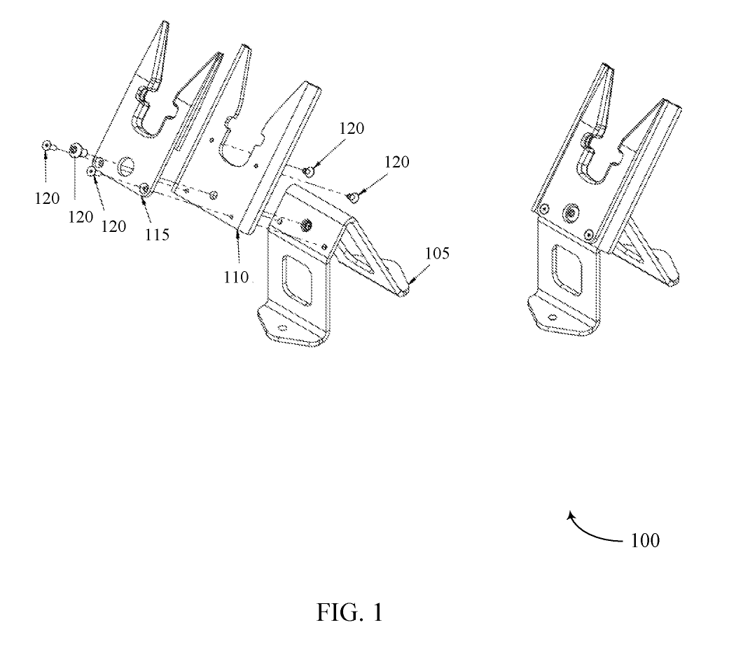

With reference to FIG. 1 an example of a tool holder assembly 100 for use on a robot is illustrated, both in perspective view and an exploded view. For this discussion the term “tools” is meant to include a range of robotic manipulators, tools, sensors, or other devices that are utilized by the robot, all of which are referred to herein simply as “tools.” The tool holder assembly 100 may include a tool holder base stand 105, a tool holder bracket support 110, and a tool holder guide 115, which may be coupled with one or more screws 120 or other securement components. One or more of such tool holders may be mounted on a robot, each having an associated tool, which may provide the robot with various tool options for use by an operator of the robot.

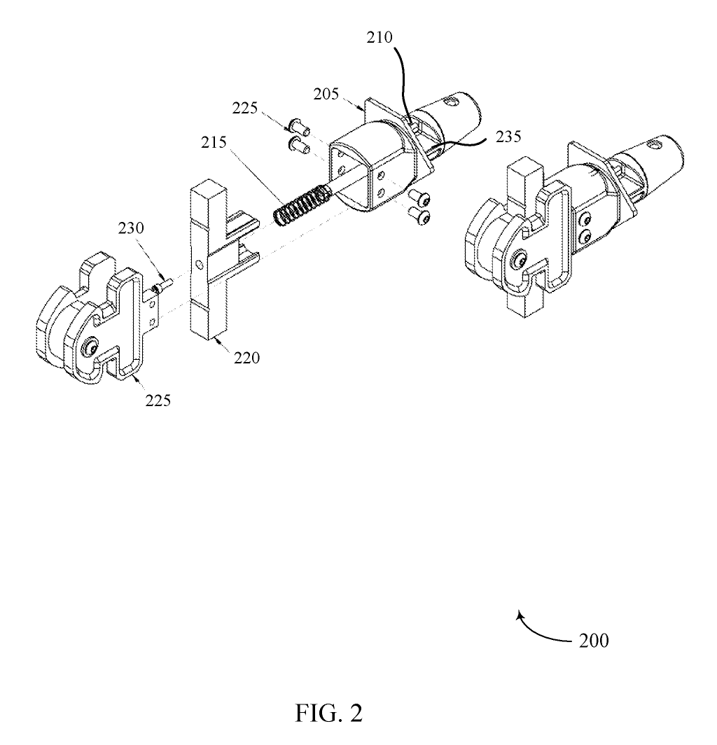

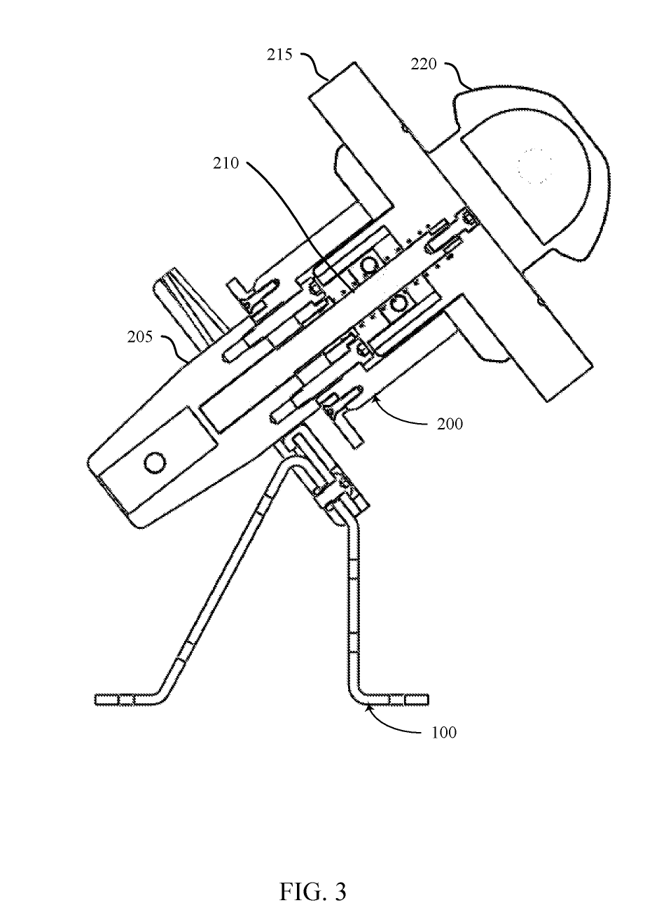

FIG. 2 illustrates perspective and exploded view of a locking guided tool changer assembly 200 according to various aspects of the present disclosure. The locking guide tool changer assembly 200 is configured to engage with the tool holder 100 of FIG. 1, which may secure the tool holder 100, and associated tool, securely until a gripper assembly engages with the locking guide tool changer 200 to release it from the tool holder 100. The locking guide tool changer 200 includes a collet base assembly 205, a collet key 215, a key extender and spring 220, a plunger key 220, and a gripper guide assembly 225, which may be secured together with screws 230 or other securement components, as illustrated in FIG. 2. A tool may be attached to the collet base assembly 205. The collet base assembly 205 may include channels 235 that may receive tool holder bracket support 110 and tool holder guide 115, and the collet key 210 may engage with a detent of the tool holder bracket support 110 and tool holder guide 115. FIG. 3 illustrates a section view of the locking guided tool changer 200 mounted on a tool holder 100.

As mentioned, the locking guided tool changer 200 has a collet key 210 and collet base 205 that integrates with tool holders 100 on the robot's platform. The tool can be placed on the tool holder 100 by engaging the plunger key 220, which may lock the locking guided tool changer 200 within a tool holder 100. Engagement of the plunger key 220 allows the collet key 210 to be moved within collet base 205, to lock or unlock the locking guided tool changer 200 and allow a tool mounted to the locking guided tool changer 200 to slide onto the tool holder 100 and lock in place. To remove a tool, the operator manipulates the robot's gripper to close onto the gripper guide assembly 225. Closing the gripper on the gripper guide assembly 225 engages the plunger key 220, moves the key extender 215 and collet key 210 within the collet base 205 to unlock the tool and allow removal of the tool from the tool holder 100, through compression of a bushing and coil spring, to allow easy movement of the collet key 215.

To remove the locking guided tool changer assembly 200 from the tool holder 100, the gripper assembly of the robot may be maneuvered to exert pressure on the plunger key 220 toward the collet base 205. This force will overcome the spring force holding the collet key 210 in the locked position. When the plunger key 220 is toward the tool holder 100, and while holding this position, the locking guided tool changer assembly 200 can be removed from the tool holder 100 assembly. The operator of the robot may remove the locking guided tool changer assembly 200 by manipulating the robot's arm to lift the unit away from the tool holder 100 and a detent in the tool holder bracket support 110 and a tool holder guide 115.

To place the locking guided tool changer assembly 200 back on the tool holder assembly 100, an operator may manipulate the robot gripper assembly to press the plunger key 220 toward the collet 205, and hold this position. The guide plate 115 of the tool holder assembly 100 may be used to help orientate the gripper in the correct position into the tool holder assembly 100. The guide plate 115 also may be used to help with depth perception when needed, such as due to the camera being used to view the gripper assembly when an operator is performing this operation. The operator may then direct the locking guided tool changer assembly 200 with the point of the guide plate 115 toward the opening of the tool holder assembly 100, and lower the locking guided tool changer assembly 200 into the tool holder assembly 100. The operator may release the pressure on the plunger key 220 resulting in the key 220 moving up and locking the locking guided tool changer assembly 200 through engagement with the detents of the tool holder bracket support 110 and a tool holder guide 115.

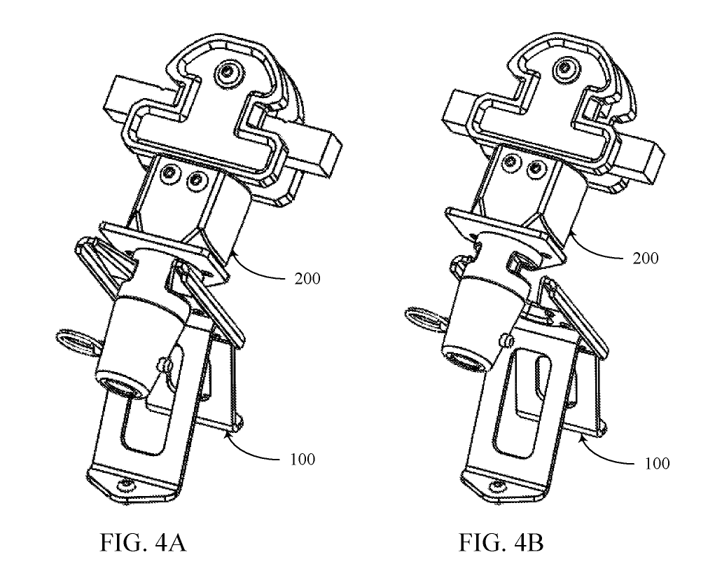

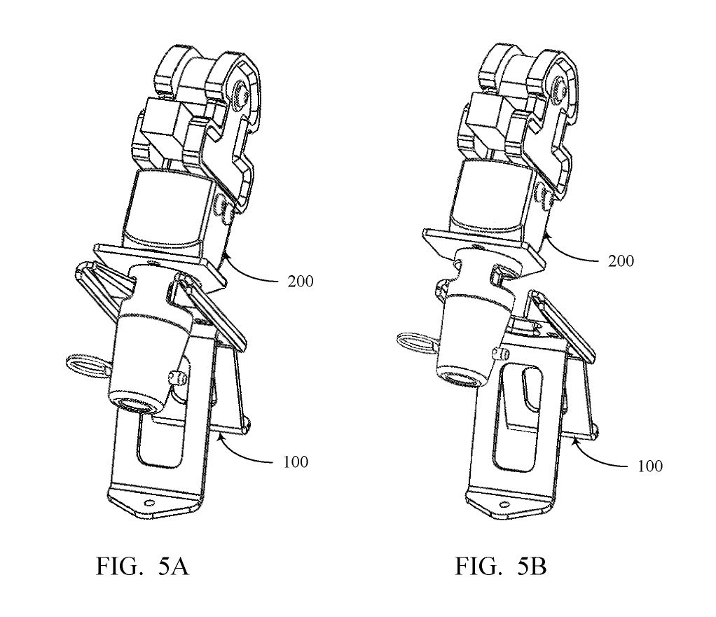

FIGS. 4A and 4B illustrate a locking guided tool changer assembly 200 according to various aspects of the present disclosure in engaged and disengaged configurations, respectively, and FIGS. 5A and 5B illustrate the locking guided tool changer assembly 200 rotated 90 degrees relative to the illustrations of FIG. 4, in engaged and disengaged configurations, respectively.

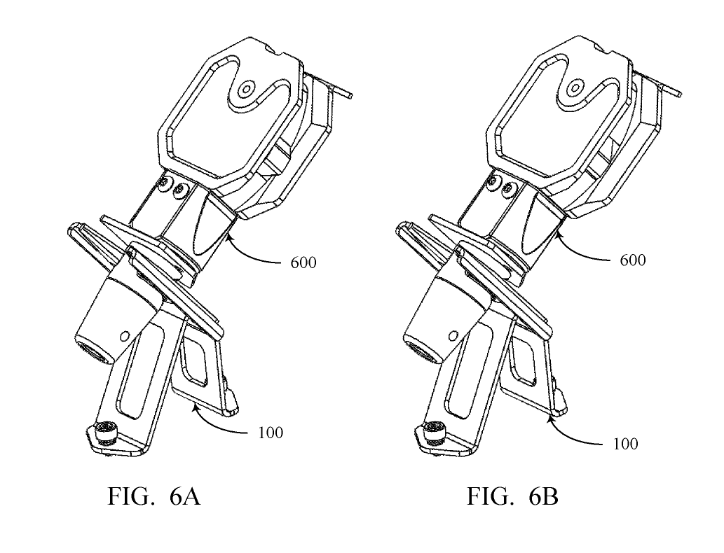

The design of the gripper guide assembly, and plunger key may be modified to reflect the gripper geometry for particular robots, and the orientation of the collet base assembly can also be rotated as necessary to reflect the orientation of the mating robotic gripper. FIGS. 6-10 illustrate another example of a locking guided tool changer assembly 600 that may be configured for a different gripper geometry.

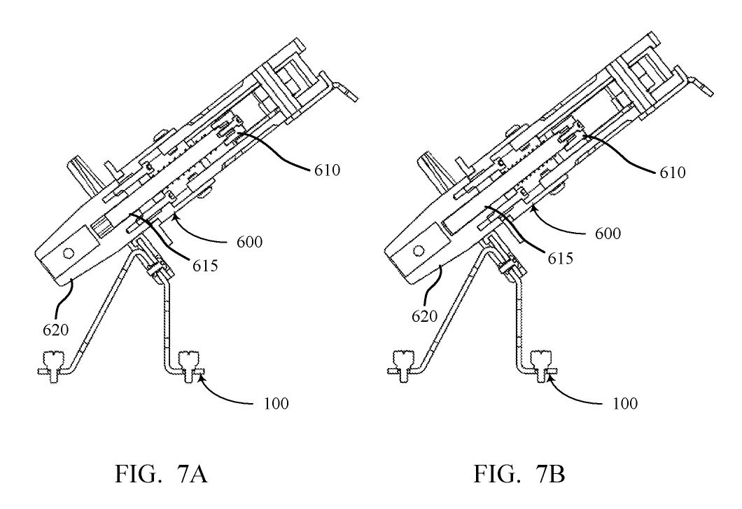

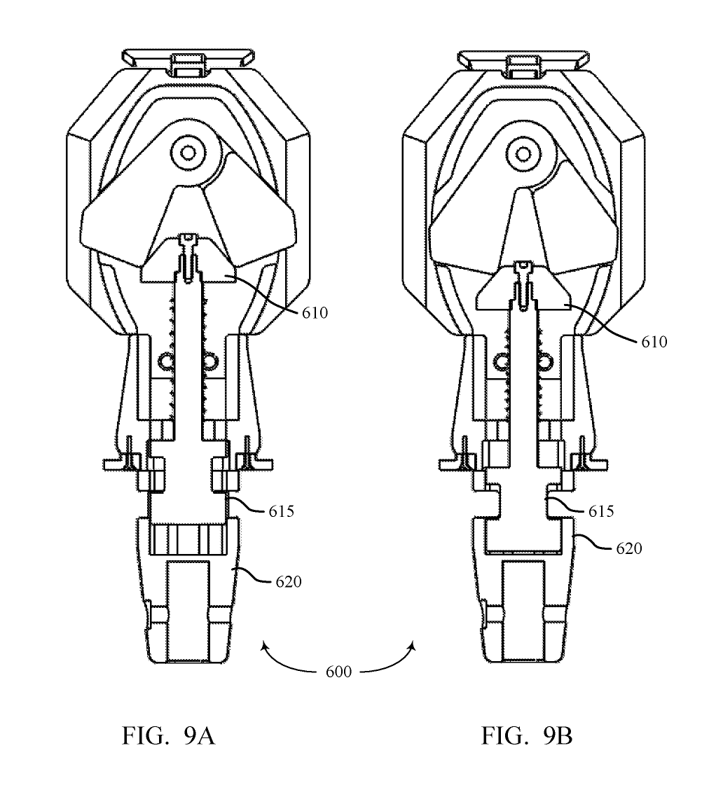

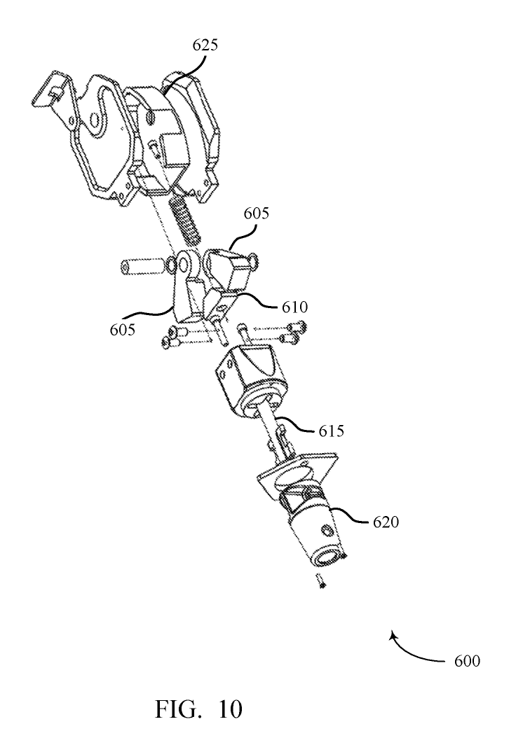

In the example of FIGS. 6-10, the locking guided tool changer assembly 600, as can be seen in the cross section views of FIGS. 7 and 9, and the exploded view of FIG. 10, includes a plunger 610 that may be actuated through mating surfaces 605. When the mating surfaces 605 are moved inward (e.g., through squeezing of a robot gripper that engages a gripper guide 625) they push down the plunger 610 to move a collet key 615 relative to a collet base 620 and allow removal of the locking guided tool changer assembly 600 from a tool holder assembly 100.

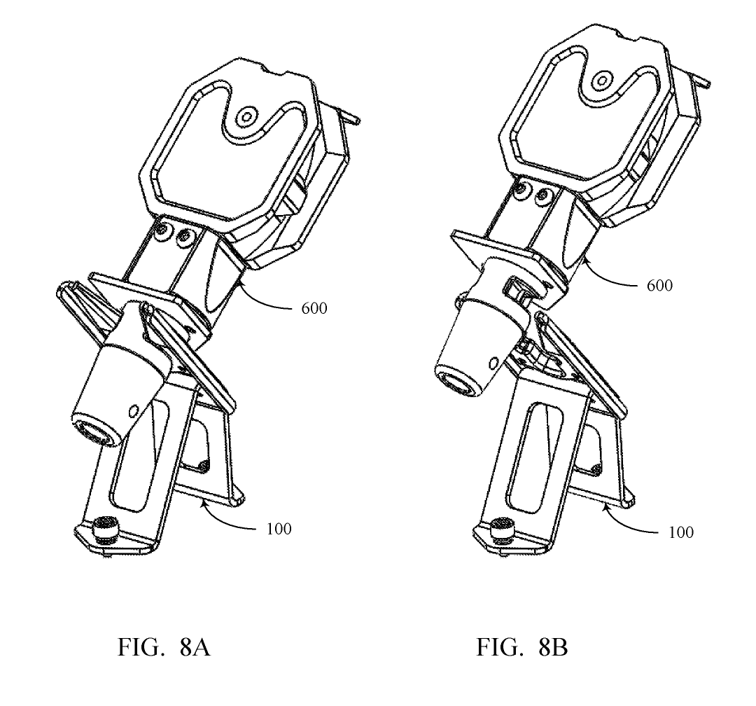

FIGS. 6A and 6B illustrate isometric views of the locking guided tool changer assembly 600 having the plunger not engaged (FIG. 6A) and engaged (FIG. 6B). FIGS. 7A and 7B illustrate side cross section views of the locking guided tool changer assembly 600 having the plunger not engaged (FIG. 7A) and engaged (FIG. 7B). FIGS. 8A and 8B illustrate isometric views of the locking guided tool changer assembly 600 having the plunger not engaged (FIG. 8A) and locked in tool holder assembly 100, and having the plunger engaged (FIG. 8B) to unlock and allow movement of the locking guided tool changer assembly 600 from the tool holder assembly 100. FIGS. 9A and 9B illustrate top cross section views of the locking guided tool changer assembly 600 having the plunger not engaged (FIG. 9A) and engaged (FIG. 9B). Finally, FIG. 10 shows an exploded view of the locking guided tool changer assembly 600 of this example.

While particular examples are described, it will be readily apparent to one of skill in the art that numerous variations may be implemented within the scope of this disclosure. For example, a shaft hole size in the collet may be resized for different tools, and a side hole of the collet may be changed to allow for a different spring pin, screw, or other securement mechanism for a tool. The plate guide of the tool holder assembly also may be changed to provide enhanced visual cues depending on the angle and orientation of the robot's camera. The plunger key could be altered to reflect the geometry of the gripper that the tool will interface with, and the gripper guide also may be changed to accommodate the gripper geometry. The compression value of the spring may be changed to alter the actuation force based on a particular robot. Additionally, the collet key geometry may be selected to match changes in the tool holder assembly that may be desirable for a particular application.

The embodiments illustrated in FIGS. 1-10 show a modular tool holder system according to aspects of the disclosure which may be mounted to a UGV robot. In the examples of FIGS. 1-10, tool holder assemblies may be mounted to a library platform assembly, thereby providing a modular library system. Such a modular library provides the ability to reconfigure the number of tool holder stations and their positions on the library. This capability allows the deployment configuration of a robot to be modified to accommodate a specific number of tools, the types and sizes of the tools, and the weight of the overall system to enhance the functionality of the robotic system to meet specific mission requirements. For example, if five small tools are desired for the robot based on the expected requirements of a specific mission, the library can be configured with those specific tool holders. If a mission is expected to require the use of two small tools and one larger tool, the unused tool holders may be removed to accommodate the space requirements of the larger tool and to minimize the weight of the overall robotic UGV.

In one example, each individual tool holder is identical, and can be installed at any tool holder position on the library. This feature reduces workload for the human operator by eliminating the need to install a particular tool holder at a specific position on the library.

It should be noted that the systems and devices discussed above are intended merely to be examples. It must be stressed that various embodiments may omit, substitute, or add various procedures or components as appropriate. For instance, it should be appreciated that, in alternative embodiments, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, structures, and techniques have been shown without unnecessary detail in order to avoid obscuring the embodiments.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A locking guided tool changer assembly, comprising:
a collet base;
a collet key coupled with the collet base, the collet key movable within the collet base to engage a detent of a tool holder;
a plunger coupled with the collet key, the plunger movable through engagement with a robotic gripper to move the collet key within the collet base.

2. The locking guided tool changer assembly of claim 1, wherein the collet base comprises channel that may receive a plate of the tool holder.

3. The locking guided tool changer assembly of claim 1, wherein the plunger is configured to engage with a gripper of a robotic vehicle, and wherein the gripper of the robotic vehicle moves the plunger relative to the collet base.

4. The locking guided tool changer assembly of claim 1, wherein the plunger is biased to hold the collet key in a locked position relative to the collet base.

5. The locking guided tool changer assembly of claim 4, further comprising a coiled spring to bias the plunger to hold the collet key in the locked position relative to the collet base.

6. The locking guided tool changer assembly of claim 1, further comprising:
a pair of opposed mating surfaces in contact with opposing surfaces of the plunger and that extend through a gripper guide, the pair of opposed mating surfaces movable relative to the opposing surfaces of the plunger to move the plunger toward the collet base and to disengage the collet key with the detent of the tool holder.

7. The locking guided tool changer assembly of claim 1, further comprising:
a tool secured to the collet base.
